(19) United States
(12) Patent Application Publication
(10) Pub. No.: US 2015/0150761 A1
(43) Pub. Date: Jun. 4, 2015

(54) CONTAINER AND METHOD FOR HANDLING AND TREATING A CONSUMABLE LIQUID

(71) Applicant: NUTRITS LTD., Tel Aviv (IL)

(72) Inventors: Ayal LANTERNARI, Atlit (IL); Asaf KEHAT, Haifa (IL)

(73) Assignees: NUTRITS LTD., Tel Aviv (IL); EPAS

(21) Appl. No.: 14/615,407

(22) Filed: Feb. 5, 2015

Related U.S. Application Data
(63) Continuation of application No. PCT/IL2013/050683, filed on Aug. 12, 2013.
(60) Provisional application No. 61/742,423, filed on Aug. 13, 2012.

(51) Int. Cl. A61J 9/02; B65D 85/804; A61J 11/04; B65D 25/54; B65D 81/38

(52) U.S. Cl. CPC A61J 9/02; B65D 25/54; B65D 81/3869; A61J 11/04; B65D 85/8046; A61J 2200/50

(57) ABSTRACT

A container and a method for handling and for treating a bio-compatible feeding liquid, or of a liquid for biological use, having an interior volume wherein the liquid is held and is distributed as a shallow layer of thickness. The feeding liquid, is disposed in contact with surface of the container having large areas. The numerical denomination of the areas may be larger than the thickness by at least 50%, or by one, two, three or more orders of magnitude. The large areas and the shallow thickness enhance rapid heat exchange between the liquid, and a fluid having a thermal capacity wherein the container is immersed. A through opening is disposed in the container for bidirectional liquid communication with the interior volume. The through opening may be coupled to a feeding bottle and to ancillary equipment.

### CROSS REFERENCE TO RELATED APPLICATION

This application claims priority under 35 U.S.C. §119(e) of International Patent Application No. PCT/IL2013/050683 filed 12 Aug. 2013, the entire disclosure of which is incorporated by reference herein.

### TECHNICAL FIELD

Embodiments of the invention relate to a container and in particular, to a container for storing, handling and treatment of a biologically compatible feeding liquid, such as food dedicated to the feeding of infants, or of a liquid for biological use.

### BACKGROUND ART

Feeding infants, or toddlers, or babies with consumable liquids such as breast milk, infant formula, or the like, is a frequently required need, and by storing such consumable feeding liquids a priori in containers, timely prepared meals may be more easily provided. Special care has to be taken to provide such feeding liquids while adhering to well-defined procedures to retain their physical and nutritional properties. Therefore, containers for storing, handling and treating such feeding liquids should be suitably designed.

Examples of ways to store liquids are found in U.S. Pat. No. 7,287,656 to Guilford, III et al., which describes a container with a first compartment and a second compartment. The first compartment defines a first opening for receiving a consumable liquid and the second compartment defines a second opening for receiving a second liquid. A primary function of the container is defined as allowing heating or cooling of a consumable with a second liquid, for heating or cooling.

Furthermore, International Patent Publication No. WO2011027134 to D. Sutherland, describes a bottle for feeding an infant. The bottle comprises a body portion adapted to be attachable to a feeding teat, the body portion having a perimeter around either at least one longitudinal section or at least one transverse section which is convoluted.

Similarly, International Patent Publication No. WO2008049630 to A. Kozlik describes a drink vessel, in particular a feeding bottle or a keg, which is formed with walls and elements that provide additional surfaces within the vessel for intensifying heat exchange between the content of the vessel and a cooling medium, in particular cooling water.

U.S. Pat. No. 4,867,325 to Julian E. G. Dransfield describes a baby bottle with a generally toroidal hollow chamber. The bottle preferably has a nipple which is positioned at an angle with respect to the toroidal chamber, and the bottle also has a bisecting tubular chamber which increases the capacity of the bottle while reducing its external size. One or more liquid crystal temperature sensing dots may be molded in the side of the bottle to facilitate the determination of overheated contents and a flexible handled brush can be used to completely clean all inner surfaces of the bottle.

US Patent Application No. 20120027903 to Julian A. Devlin recites a heat exchange apparatus with an outer shell defining a cavity and a volume-occupying member received within the cavity, but does not teach a hollow duct that passes through the first wall, through the interior volume, and through the second wall, and opens to the exterior of the container without entering in fluid communication with the interior volume.

However, the background art stops short of providing means for ascertaining uniform heat transfer to the consumable liquid stored in the feeding bottle. Uniform heat transfer is meant to include the prevention of hot or cold spots from developing in the consumable feeding liquid during the heat transfer treatment process. Furthermore, the background art does not relate to means for facilitating the transfer of say breast-milk from a milk pump to a baby feeding bottle.

### TECHNICAL PROBLEM

For example, modern life circumstances, medical conditions of a nursing mother, and/or other situations may require the feeding of a baby by use of stored breast-milk or of an infant feeding formula, referred to as being a consumable feeding liquid. Breast-milk may be extracted by help of a breast-milk pump for example, and then be stored according to a well-defined cooling procedure to prevent loss or deterioration of nutritional properties. Preferably, cooling should be uniform through the entire volume of breast-milk, and be fast to reach the desired storage temperature. When necessary for feeding a baby, retrieval out of cold storage and heating-up to baby-food feeding temperature has to be uniform throughout the volume of the breast-milk, be void of hot spots, and is required to be fast. For example, a conventional nursing bottle does not meet the expected cooling and heating requirements. In other words, heat transfer from or to the consumable liquid contained in the nursing bottle is far from being uniform over the volume of the consumable feeding liquid.

### SOLUTION TO PROBLEM

There is provided a container configured for coupling in liquid communication with ancillary devices, such as for example with a breast-milk pump and with a nursing bottle. The container should be able to hold and hermetically seal-off consumable feeding liquids from the exterior environment, and feature uniform and fast heat transfer characteristics. Such characteristics may be obtained by shaping the container to have a container interior volume accommodated to form a layer of liquid having a uniform thin thickness that is small relative to surface of the container. The ratio of the thickness of the uniform layer of feeding liquid to the thickness of surface thereof may range from 1:10 and reach 1:100. In other words, the surfaces of the container operative for heat transfer may easily reach two, three, four or more orders of magnitude over the thickness of the layer of consumable liquid. The container may be flat or bowl-like. Heat transfer refers hereinbelow to both heating and cooling of the consumable liquid, with reference to a previous temperature at which the consumable liquid is held in the container.

### ADVANTAGEOUS EFFECTS OF INVENTION

The provided container is configured to hold feeding liquid in a thin uniform layer and ensures uniform, gradual, and fast change of temperature when heated or cooled, due to enhanced heat transfer properties of the container. One major property is the geometrical configuration of the container, but other considerations also include the conductive properties of the material(s) from which the container is made. Thereby the container fulfills the desired conditions related to the preservation of the nature of the liquid stored therein. This is true for the nutritional properties of breast milk as well as for a formula for feeding infants as for the properties of biological fluids.

### SUMMARY

The following embodiments and aspects thereof are described and illustrated in conjunction with systems, tools, and methods which are meant to be exemplary and illustrative, but not limiting in scope.

It is an object of the embodiments of the present invention to provide a container for a consumable liquid, the container having an axis, a first wall and a second wall separated apart by a closed periphery and configured to form an interior volume to hold the consumable liquid therein. The interior volume includes a first distance length dimension separating apart between the two walls and a second distance length dimension that separates apart between two opposite end points disposed on the closed periphery of the container, where the second distance length is at least five times larger than the first distance length.

The container may comprise one or more openings formed through one of the walls for providing feeding liquid communication between the interior volume of the container and an exterior thereof.

Preferably, the at least one opening of the container is configured for coupling to one or more ancillary devices.

Typically, the ancillary device is at least one of a nursing bottle, a breast milk pump, an adapter, a dedicated handle, and a feeding teat.

It is another object of the embodiments of the present invention to provide a container where each wall out of the two walls separates apart between the interior volume and the exterior of the container, and where the container comprises a hollow duct that passes through the interior volume and opens to the exterior of the container on the exterior of the two walls.

It is yet another object of the embodiments of the present invention to provide a container where the substantial axial first distance length dimension ranges between 2 to 20 millimeters, or extends between 3 to 10 millimeters, or spans between 4 to 6 millimeters.

It is still an object of the embodiments of the present invention to provide a container where the second, third, or fourth distance length dimension ranges between 30 to 400 millimeters, or extends between 120 to 300 millimeters, or spans between 150 to 250 millimeters.

In accordance with the embodiments of the present invention, there is provided a method for handling and for treating a consumable liquid for feeding infants, comprising the steps of: a) providing a container with two walls and a peripheral envelope, the two walls being spaced apart by and at the peripheral envelope, and thereby form an interior volume that is enclosed between the two walls and the envelope, b) providing at least one through opening formed through one of the two walls for allowing bidirectional feeding liquid communication with the interior volume of the container for pouring the consumable feeding liquid therein and thereout, and c) coupling to the at least one through opening to an ancillary device operative for the treatment of the feeding liquid such as at least one of heat transfer, transfer of the feeding liquid and handling of the container.

Still in accordance with the exemplary embodiments of the present invention, there is provided a method for handling the container that includes operation and agitation of the container in contact with a fluid having a thermal capacity for exchanging heat therewith.

Additionally, with the method of the present invention, the ancillary device is a nursing bottle and operation includes bidirectional transfer of consumable liquid into and out of the nursing bottle.

In addition to the exemplary aspects and embodiments described above, further aspects and embodiments will become apparent by reference to the figures and by study of the following detailed descriptions.

### BRIEF DESCRIPTION OF THE DRAWINGS

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a cross sectional side view of a container for a consumable feeding liquid which is coupled to a feeding bottle and immersed in a fluid having a thermal capacity;

FIG. 2 illustrates an exploded perspective view of the container and the feeding bottle shown in FIG. 1;

FIG. 3 depicts a cross sectional side view of the container of FIG. 1;

FIGS. 4A and 4B present respectively, an adaptor and the container of FIG. 1 coupled to the adaptor;

FIGS. 5A shows another exemplary embodiment of the container depicted in FIG. 1;

FIG. 5B shows a feeding bottle coupled to the container of FIG. 5A, ;

FIG. 6 depicts a detail of an embodiment of a hollow duct passing through the container;

FIG. 7 depicts yet another embodiment of the container shown in FIG. 1;

FIGS. 8 to 12 show various coupling configurations of a container;

FIGS. 13 and 14 present additional exemplary embodiments of the container;

FIG. 15 is a detail of a thermometer coupled to a container;

FIG. 16 illustrates an exemplary annular container;

FIG. 17 shows a deployed view of the container of FIG. 16;

FIG. 18 illustrates an additional adaptor;

FIG. 19 depicts a detail of a hollow duct concentric with an opening in a container; and

FIG. 20 is an isometric view of still another container.

It will be appreciated that for simplicity and clarity of illustration, elements shown in the figures have not necessarily been drawn to scale. For example, the dimensions of some of the elements may be exaggerated relative to other elements for clarity. Furthermore, where considered appropriate, reference numerals may be repeated within the figures to indicate like elements.

### DESCRIPTION OF EMBODIMENTS

The description hereinbelow describes various embodiments of a container 10 and of a method for handling and for treating a consumable liquid, or a liquid for biological use. The container 10 may be dedicated to hold and store feeding fluids that require treatment. Such treatment may include rapid and uniform heating or cooling throughout the fluid for preserving their nutritional or vital characteristics, such as for example with biological compatible feeding liquids, and in particular with breast milk. Breast milk is also known as expressed breast milk, or human breast milk, or human female milk. The container 10 may furthermore be used to hold consumable liquids such as infant formulae, and milk for example, for feeding infants, toddlers, and babies. Alternatively, the container 10 may be accommodated to hold liquids for biological use.

Preserving infant consumable feeding liquids in appropriate storage conditions is of great importance to the well being of infants. The container 10 of the present invention has therefore to be stored in appropriate storage surroundings, such as in a temperature controlled environment, for example in a refrigerator, or in a freezer, in particular when the consumable feeding liquid has to be stored for a relatively long period of time. A container 10 holding breast milk that was previously extracted from a nursing mother by use of a biological liquid extraction device, e.g. a breast-milk pump, may be stored at a specific temperature for a given length of time. For example, at a temperature of 4° C., storage may be possible for a period of time not exceeding five days.

It is noted that the term infant, should be understood in a broad sense to include potential consumers of the liquids held in the container of the various exemplary embodiments described hereinbelow, such as toddlers, young children, and babies. In addition it is noted that directional terms appearing throughout the specification and claims, e.g. “forward”, “rear,”, “up”, “down” etc., and derivatives thereof, are used for illustrative purposes, and are not intended to limit the scope of the appended claims Moreover, the directional terms “down”, “below” and “lower”, and derivatives thereof, may define substantially same directions.

Before feeding an infant with a consumable feeding liquid FL that was previously cooled and stored in the container 10, it may be required to heat the liquid. Transfer of heat to the container 10 holding the feeding liquid therein may be performed by exposing the container to a fluid having a thermal capacity. It is possible to warm the feeding liquid held in the container 10 by immersion in a fluid having a temperature higher than that of the cold feeding liquid. For example, a flow of hot gas, such as hot air from an air blower, or a flow of hot liquid, such as hot water exiting out of a faucet, or immersion into hot liquid such as hot water contained in a pan, may achieve the desired results.

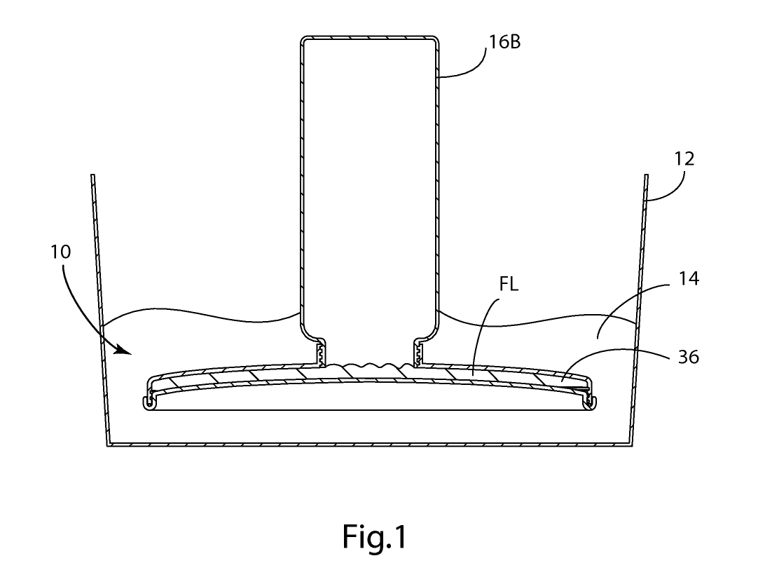

FIG. 1 shows an exemplary embodiment of the container 10 holding therein a consumable liquid FL, or feeding liquid FL. The container 10 may be warmed by immersion in a vessel 12, such as a cooking pan for example, containing a fluid 14 having a thermal capacity, such as hot water. The temperature to which the consumable feeding liquid in the container 10 should be warmed-up may depend on the infant being fed. However, heating of the consumable feeding liquid to body temperature is preferable in most cases.

As illustrated in FIG. 1, the container 10 storing the consumable feeding liquid therein may be kept immersed and held manually in the hot water while preventing direct contact with a hand. This may be achieved by use of a coupling device, such as a handle element that remains out of the hot water. In FIG. 1, the handle element may optionally be selected as an ancillary device 16, such as for example, an empty nursing bottle 16B, or a baby bottle 16B, or a dedicated handle 16H, or an adapter 38. Fixed but releasable coupling of the nursing bottle 16B to the container 10 permits safe immersion into hot water. Since the container 10 is configured to perform as an efficient heat transfer element or heat exchanger, sufficient heating of the consumable feeding liquid FL for feeding a baby may be achieved after an immersion that lasts but for a short length of time. Preferably, the container 10 may be gently agitated in mixing motion while being immersed.

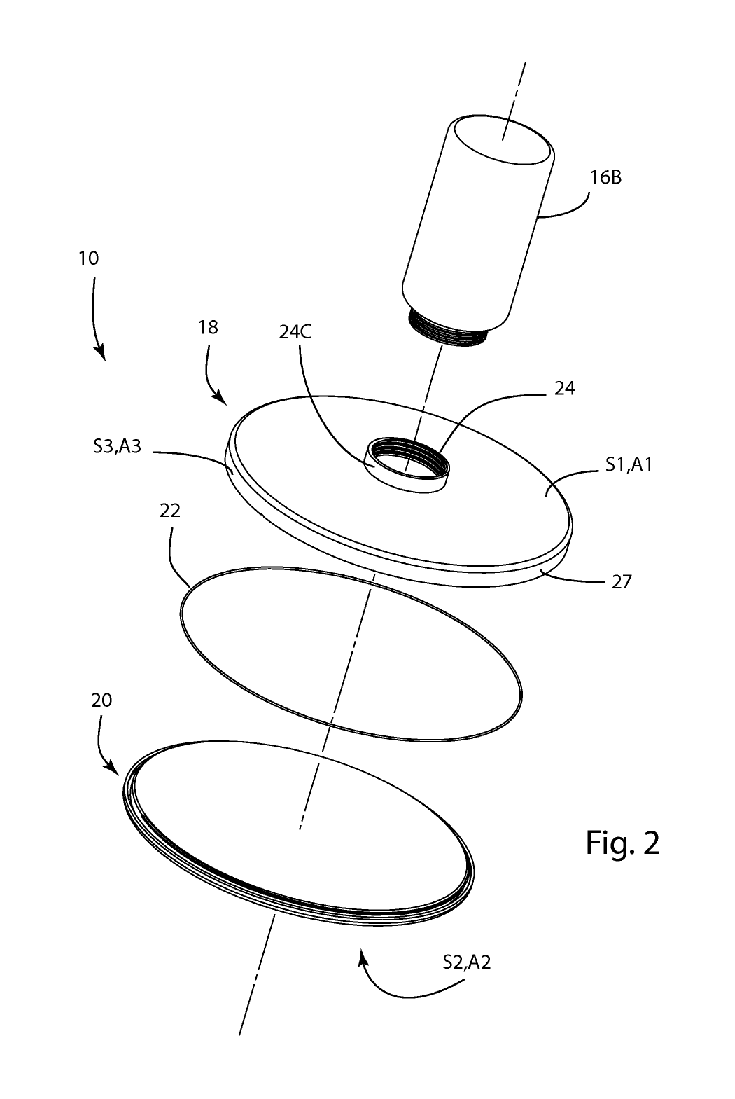

FIG. 2 depicts an exploded view of an exemplary embodiment of the container 10 which includes a first shell 18 and a second shell 20 that may be disk-like. The first shell 18 and the second shell 20 are configured for mutual assembly to form the container 10 therebetween. Mutual assembly may be achieved by snap-fit of the first shell 18 with the second shell 20, with or without the help of a sealing element disposed intermediate between both shells, respectively 18 and 20. Such a sealing element 22 may be selected as a rubber ring 22, or as an O-ring, which is a ™. Alternatively, a screw thread coupling may be employed for the assembly of the first shell 18 to the second shell 20.

To permit transfer of consumable feeding liquid FL into the interior volume 36 and out to the exterior EX of the container 10, there is provided at least one through opening 24, shown for example to be entered in the first shell 18 in FIG. 2. It is noted that the through opening 24 may be oriented in a selected desired orientation relative to a shell 18 or 20. Preferably, the at least one opening 24 may be formed with a collar 24C having a female screw thread to accommodate releasable fixed and sealed coupling with the male screw thread of a nursing bottle 16B. The same female screw thread may further be used for connection of the container 10 to ancillary devices 16, such as a biological liquid extraction device like a breast-milk pump 16P, a nursing bottle 16B, an adapter 38, a dedicated handle 16H, or a feeding teat BT, or feeding bottle teat BT. Instead of a screw thread or threaded connection coupling, the at least one through opening 24 may be configured to snap-fit or interference fit in releasable hermetical sealed liquid coupling with an ancillary device 16, such as a nursing bottle 16B, or a breast-milk pump 16P, or an adapter 38, or even with a feeding bottle teat BT, or feeding teat BT, or teat BT. Hermetical sealing is understood as including both liquid-tight and air-tight hermetical sealing.

When the first shell 18 is assembled to the second shell 20, the through-shell opening 24 may be hermetically closed by a cap C or a cover C, whereby a hermetically sealed container 10 is formed. Typically, the shells 18 and 20 of the container 10 may be made of transparent or translucent material, such as a plastic material having desired heat transfer properties, namely polyethylene for example. Furthermore, each shell 18 and 20 may be made as one single piece part or as a part made out of a plurality of assembled pieces, but the container 10 may also be produced as one single piece part. Moreover, each shell 18 and 20 may be produced out of one or more than one type of material, and each material may have different properties, such as a different rigidity for example. For example, a shell 18 may be made as one single piece but be fabricated out of two different kinds of materials, by processes well known to those skilled in the art, including single and double injection molding, ultrasonic welding and gluing with adhesives. Thus, a rigid shell 18 or 20 may be produced out of rigid material but for example the collar 24C of the through opening 24 thereof may be implemented out of a less rigid or a softer type of material, possibly for snap-fit purposes. Evidently, even better heat transfer properties may be achieved with a container made out of metal alloys, such as stainless steel or aluminum.

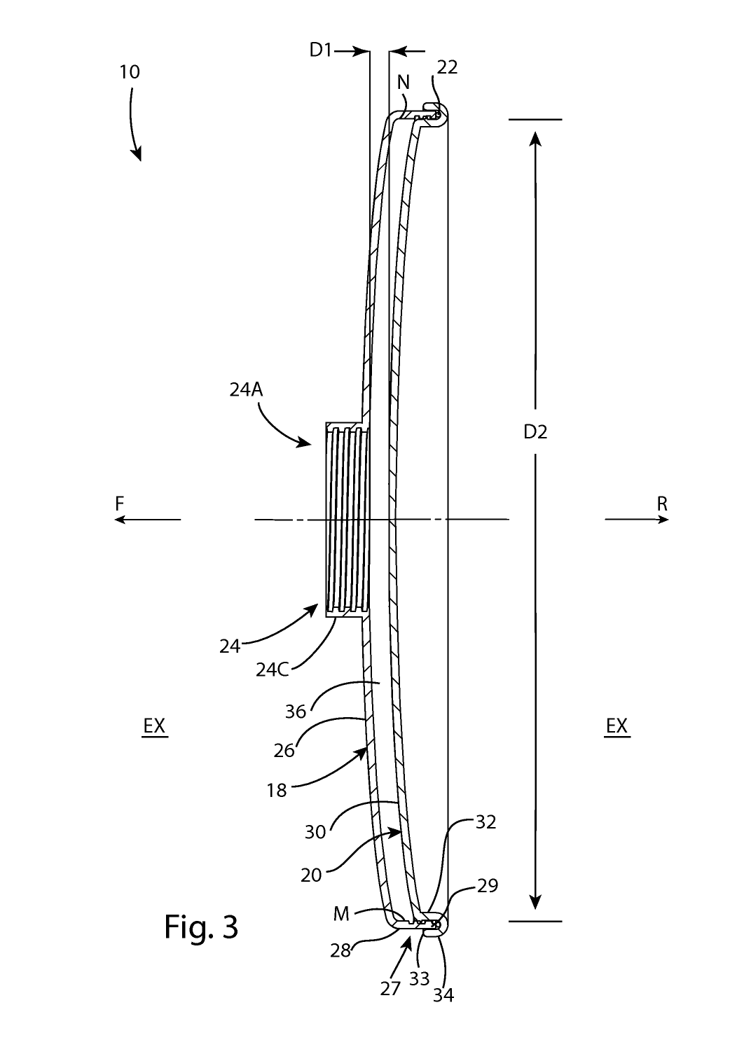

FIG. 3 is a partial cross-section of an exemplary embodiment of the container 10, which has an axis X. In FIG. 3, the side of the container supporting the at least one opening 24 opened in the first disk-like shell 18 points to a forward direction F, while the side of the second disk-like shell 20 is oriented toward a rear direction R. The first disk-like shell 18 and the second disk-like shell 20 are formed about an axis X, as shown in FIG. 3. The first shell 18 may have a first wall 26, which extends into a first peripheral envelope 28 that may be substantially concentric to the axis X. In one exemplary embodiment, the first wall 26 may be configured as a shallow cup or a pronounced dome, or a cone, or a pyramid, to form a convex cup-like first shell 18, or be selected as a flat planar first wall 26 that may be perpendicular to the first peripheral envelope 28 and to the axis X.

The second shell 20 may have a disk-like second wall 30, which extends into a second peripheral second envelope 32 that may be substantially concentric to the axis X shown in FIG. 3. The second wall 30 may be configured as a shallow cup or a pronounced dome, or a cone, or a pyramid, to form a concave cup-like second shell 20, substantially parallel to the first wall 26 when both shells 18 and 20 are coupled in assembly. Alternatively, the second wall 30 may be selected as a flat planar second wall 30 that is perpendicular to the first peripheral envelope 28 and to the axis X. In assembly, the peripheral extremity 33 of the second envelope 32 may extend axially away from the second wall 30 and may be bent in the rear direction R, away from the axis X, and then back over the peripheral extremity 29 of the first peripheral envelope 28, to the forward direction F to form a peripheral lip 34 shaped as a ridge. Thereby, the second wall 30 may be disposed substantially parallel to the first wall 26 and may be distanced away therefrom by a closed periphery 27 to form the container 10. Evidently, the closed periphery 27 may have different configurations. The first shell 18 and the second shell 20 may be closed together in a re-openable coupling mode by use of either a snap fit coupling, or with a screw thread coupling, and may be tightly and hermetically sealed to prevent passage or leaks of liquid thereout either without or without the use of a peripheral seal 22 disposed therebetween.

In an assembled state of the exemplary embodiment of the container 10 shown in FIG. 3, the first shell 18 and the second shell 20 are axially aligned and fitted to each other such that the first wall 26 and second wall 30 respectively, are placed in mutually spaced apart and substantially parallel disposition. In this state of assembly, the peripheral extremity 29 of the first peripheral envelope 28 bridges the axial distance between the first wall 26 and the second wall 30, and is then disposed in a ridge created by the peripheral extremity 33 of the second envelope 32, which is formed by the forwardly bent lip 34. For proper hermetical sealing, the sealing element 22 may be disposed between the peripheral extremity 29 of the first peripheral envelope 28 and the ridge formed by the forwardly bent lip 34 of the second peripheral envelope 32.

The resulting assembled state of the exemplary embodiment of the container 10, shown in FIG. 3, thus forms a structure that encloses an interior volume 36 that is “trapped” between the first and second shells, respectively 18 and 20. The interior volume 36 is enclosed by the axially spaced apart first and second walls 26 and 30 respectively, and by the closed periphery 27. The at least one through opening 24 of the container 10 may extend through the first wall 26, or through the second wall 30, and may be aligned with the axis X to provide a passage for liquid communication into the interior volume 36 and out thereof to the exterior EX of the container. Each wall out of the two walls, respectively 28 and 32, comprises an interior face facing toward and into the interior volume 36 and an exterior face facing away from the interior volume toward the exterior EX of the container. More than one through opening 24 is possible, and FIG. 7 shows two such openings 24.

In the embodiment shown in FIG. 3, the through opening 24 may have a female screw thread that accommodates coupling to an ancillary device 16 having matching male screw threads. Nevertheless, for coupling to an ancillary device 16 having matching female screw threads, the opening 24 may have a male screw thread. Moreover, the opening 24 may have more than one coupling means selected alone or in combination out of a set having an exterior male screw thread, an interior female screw thread and a snap fit coupling configuration. Thus, coupling means may be appropriately provided to the through opening 24 for allowing hermetical coupling to different types of ancillary devices 16, such as breast-milk pumps 16P, nursing bottles 16B, adapters 38, handles 16H, feeding teats BT, and other dedicated devices for example.

It is noted that the first and the second wall, 26 and 30 respectively, as shown in the exemplary embodiment of FIG. 3, may be shaped as a dome or as a curved cap-like structure. However, other embodiments of the container 10 may feature first and second walls 26 and 30 respectively, having a structure with other geometries, such as a flat or relatively planar geometry which may be implemented to have a circular or polygonal periphery 27 for example. Furthermore, the first and the second wall, 26 and 30 respectively, may preferably be disposed in a substantially mutually parallel relationship so that a substantially equal axial distance is maintained therebetween. With reference to FIG. 3, it is shown that the interior volume 36 enclosed, or “trapped” between the first and second shells, 18 and 20 respectively, may be defined to have an axial depth with a first distance length dimension D1 stretching the shortest straight line distance separating apart between the first and the second wall, respectively 26 and 30. The word ‘substantially’ is used in view of the fact that where one wall is missing, such as at the trough opening 24, then rigorously speaking, there are no two walls between which a distance may be measured. The trough opening 24 thus forms a small singular local instance where the layer of the feeding liquid FL may not be exactly uniform, thus be different from having the thickness of the first distance length dimension D1. However, the trough opening 24 covers just a small portion of a first shell 18 or of a second shell 20, and therefore, a small discrepancy may be accepted. The same is true for the distance length dimensions referred to hereinbelow as the second, third, and fourth distance length dimensions, respectively D2, D3, and D4. The first distance length dimension D1 shapes the volume of feeding liquid FL contained in the interior volume 36 into a substantially uniform layer having a shallow depth of thickness D1.

Furthermore, still with respect to FIG. 3, the interior volume 36 may have a second distance length dimension D2 spanning the distance along directions that may be radially perpendicular to the axis X and separating apart between two opposite portions, possibly two diametrically opposite portions, of the envelope 28, or the closed periphery 27. The second distance length dimension D2 is a segment, shown as a straight line segment in FIG. 3, which extends between and is bound by two end points, namely first and second end points M and N respectively. The container 10 may be configured for the axial first distance length dimension D1 of the interior volume 36 to be relatively small, for example by at least half an order of magnitude, and even an order of magnitude or more, relative to the second radial distance length dimension D2. This means that the ratio of the first axial length dimension D1 to the second distance or diametrical length distance dimension D2 may be at least 1:10, preferably from 1:20 to 1:40, and may reach 1:50 or even more.

Consumable liquids FL may be safely stored and sealed hermetically in the interior volume 36 of the container 10. Such consumable liquids FL may be entered into the interior volume 36 and be retrieved thereout to the exterior EX thereof, through the open through-aperture opening 24, which allows bidirectional liquid communication. The through opening 24 may thus be used for receiving and for dispensing consumable liquid FL therethrough, into and out of the interior volume 36. For example, for receiving breast-milk from an ancillary device 16, such as a breast-milk pump 16P and for bidirectional transfer of breast-milk with respect to a nursing bottle 16B. A closure cap C, or cap C, configured to hermetically seal the at least one opening 24, may seal-off the consumable liquid held in the interior volume 36 of the container 10. After filling the interior volume 36, the opening 24 may be closed and hermetically sealed by the cap C such that the consumable liquid may be kept sealed-off from the exterior EX of the container 10, thus sealed-off from the exterior environment.

In the exemplary embodiment shown in FIG. 1, the empty nursing bottle 16B may first be used to serve as a handle 16H that is firmly coupled to the container 10 for holding and for immersing the container 10 into a fluid 14 having a thermal capacity for heat transfer purposes, such as hot water for example. Thereafter, the nursing bottle 16B may be filled with the consumable liquid FL, e.g. with breast milk, by grasping the nursing bottle 16B for retrieving the container 10 out of the pan 12, and next, overturning the container 10 to become disposed on top of the nursing bottle 16B. Gravitational forces will then drive the consumable feeding liquid FL out of the container 10, via the through opening 24, and into the nursing bottle 16B. It then suffices to disconnect the nursing bottle 16B from the container 10, and then to either affix a nursing teat BT to the nursing bottle for feeding an infant, or to fetch a cap C to hermetically close the nursing bottle 16B.

As described hereinabove, the first distance length dimension D1 is substantially smaller relative to the larger second radial length distance dimension D2 of the interior volume 36 of the container 10. The container 10 is thereby configured to store the consumable liquid as a shallow layer of substantially even-depth having the first distance length dimension D1 as thickness. Such a uniform thin layer of consumable liquid FL disposed in a container 10 made of appropriately selected material, ensures the provision of enhanced heat exchange properties to the various embodiments of the present invention. In other words, the container 10 is configured for rapid heat exchange, i.e. in cooling and/or in heating, of the consumable liquid FL contained therein. Likewise, heat exchange is substantially uniform throughout the depth of the layer of consumable liquid FL, thereby avoiding spots of extreme temperature, such as hot spots or cold spots. Well-controlled uniform temperature of the consumable liquid is imperative to prevent harm to the infant that is being fed, and to maintain the nutritional properties of the consumable liquid.

Heat-transfer computations followed by experiments have demonstrated preferable dimensions for the container 10. The interior volume 36 of the container 10 should preferably have a radial second distance length dimension D2 ranging between 30 and 400 mm, or better between 120 and 300 mm, or even better between 150 and 250 mm. The corresponding first distance length dimension D1 should preferably span from 2 to 20 mm, or better from 3 to 10 mm, or even better from 4 to 6 mm. The thickness of the two shells, respectively 18 and 20, may range between 0.5 millimeters and 2 millimeters, or preferably range from 0.8 millimeters to 1.2 millimeters.

The container 10 may have one or more through openings 24, which are configured for hermetical sealed liquid communication with ancillary devices 16. When not in use, a through opening 24 may be closed by a cap C1 similar to the cap C. However, one size of through opening 24 may probably not match the various openings available with the many and different ancillary devices existing on the market. Therefore, ancillary equipment 16, such as one or more suitably configured adapters 38 may be practical. An adapter 38 may be configured as a short length of tube having a first open end 38F disposed in liquid communication with a second open end 38S, both of which ends may be hermetically sealed close with an appropriate stopper or cap C2, similar to the cap C. The first open end 38F and the second open end 38S may have the same or different sizes.

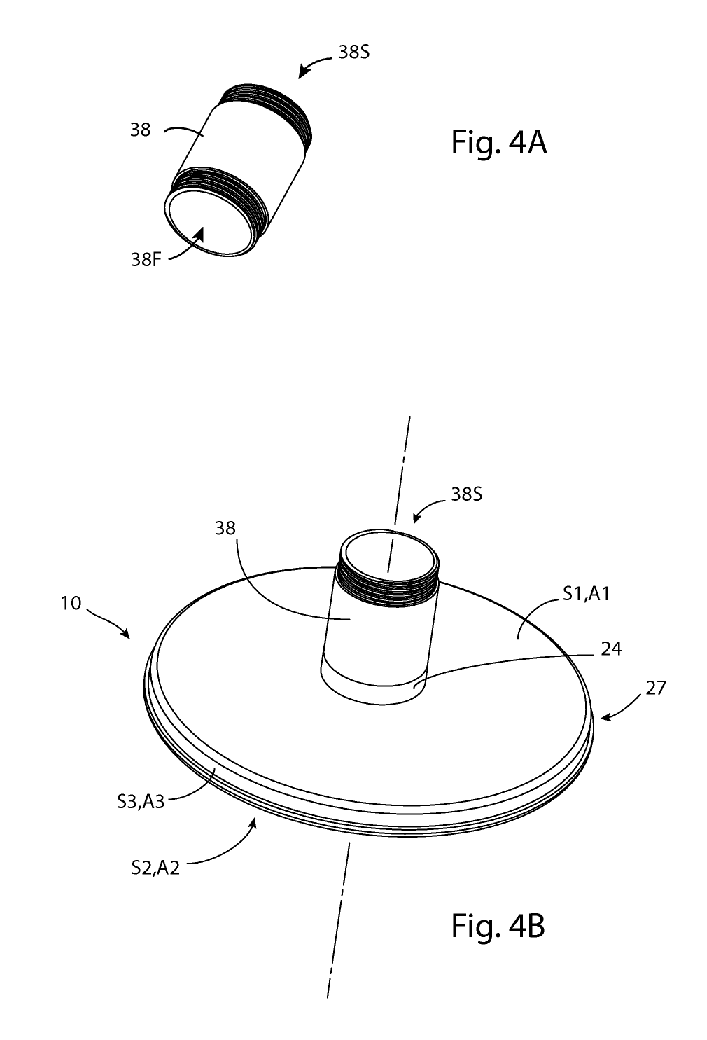

FIG. 4A depicts an exemplary embodiment of an adapter 38, and FIG. 4B illustrates an adapter coupled to the container 10. For example, the adapter 38 may be provided with a first open end 38F configured to be coupled to the opening 24 of the container 10, and with a second open end 38S configured to be coupled to an opening of an ancillary device 16, such as a milk pump 16P or a nursing bottle 16B, or a handle 16H or to a cap C or C3. Furthermore, the adapter 38 may have a male screw thread on the exterior EX at both the first and the second open end thereof, respectively 38F and 38S, or have a female screw thread on the interior at both the first and the second open end thereof, or have a combination of a male and/or female screw threads at each one or both open ends thereof. The purpose of the adapter 38 is to allow hermetically sealed bidirectional liquid communication coupling in association with available ancillary devices 16. However, the adapter 38 may also be coupled to the container 10 and be used as or instead of a dedicated handle 16H for example for holding the container, say in immersion in hot or cold water. It is noted that the adapter 38, the cap C, and the dedicated handle 16H may also be considered as an ancillary device 16. In other words, a through opening 24 may be accommodated for providing reversible hermetical coupling with one or more ancillary devices such as a breast milk pump 16P, or a feeding bottle 16B, or an adaptor 38 or 38B, or a cap C, or a nursing teat BT.

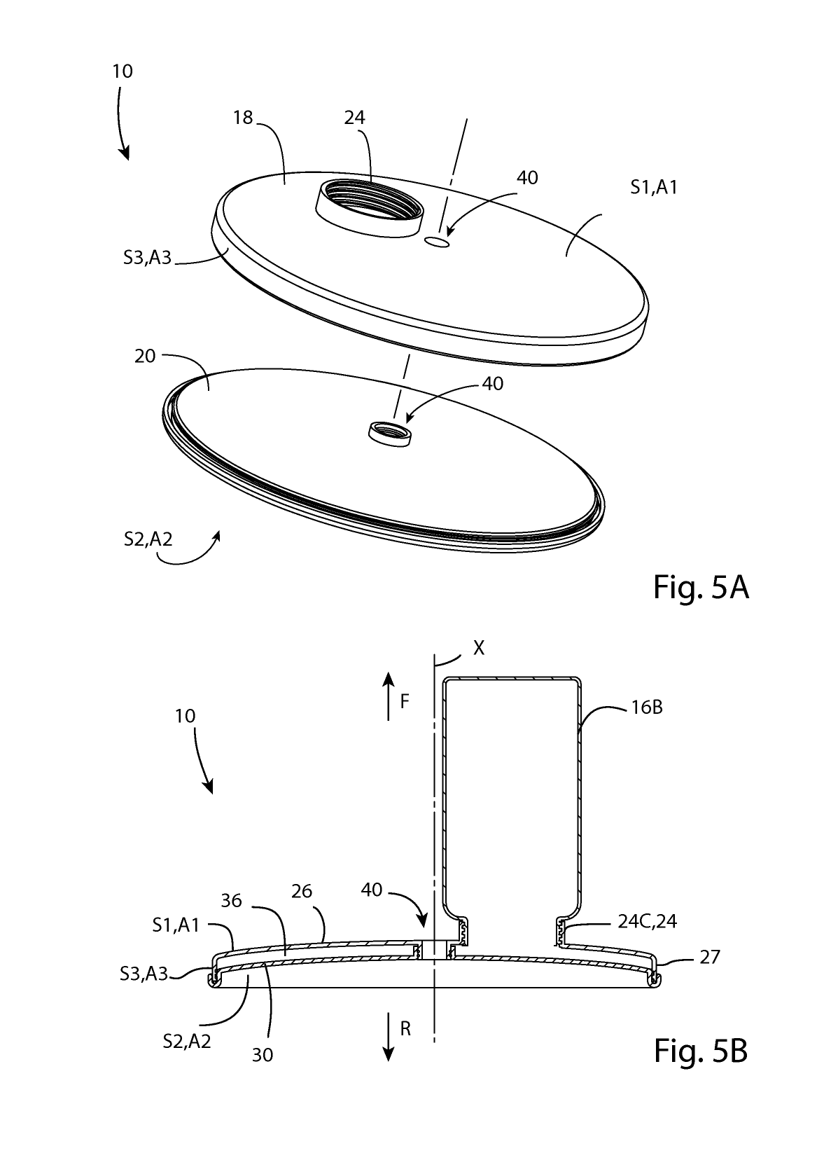

FIGS. 5A, 5B, 6 and 7 illustrate an exemplary embodiments of the container 10, which may be provided with a hollow duct 40 that crosses through the thickness of the container 10 from side to side. The hollow duct 40 passes through both the first shell 18 and through the second shell 20, thus throughout the container 10, and opens to the exterior EX of the container, without entering in fluid communication with the interior volume 36. Hence, the hollow duct 40 provides a hermetically sealed bidirectional fluid 14 communication passage throughout the axial dimension of the container 10 and across the interior volume 36, from the exterior EX of the side of the first wall 26 facing the forward direction F to the opposite exterior EX of the side of the second wall 30 that faces the rearward direction R.

In an embodiment with a hollow duct 40 aligned with the axis X, the through opening 24 of the container 10 may be disposed eccentrically, thus away from the axis X. Preferably, the hollow duct 40 may be disposed to extend along the axis X and pass through, or close to the apex AX of the container 10.

The hollow duct 40 may facilitate the immersion of the container 10 in a fluid 14 having a thermal capacity into which it may be submerged for heat exchange purposes. The descent of the container 10 into the fluid 14, rear side R first as shown in FIG. 1, may be hindered by air becoming trapped against the descending container 10, and especially so for a container 10 having a pronounced curvature. Such opposition to immersion may be increased when a dome-shaped container 10 is used. Air may become trapped at the rear side R of the container 10, in particular at a location near to the apex AX of the second wall 30. The hollow duct 40 may prevent, or at least alleviate the pressure of the trapped air against the container 10 when in descent into, for example hot water, by allowing air to escape therethrough. With an air escape route such as provided by the duct 40, the container 10 may be easily immersed into and retrieved out of a fluid 14 having a thermal capacity, for heat exchange therewith.

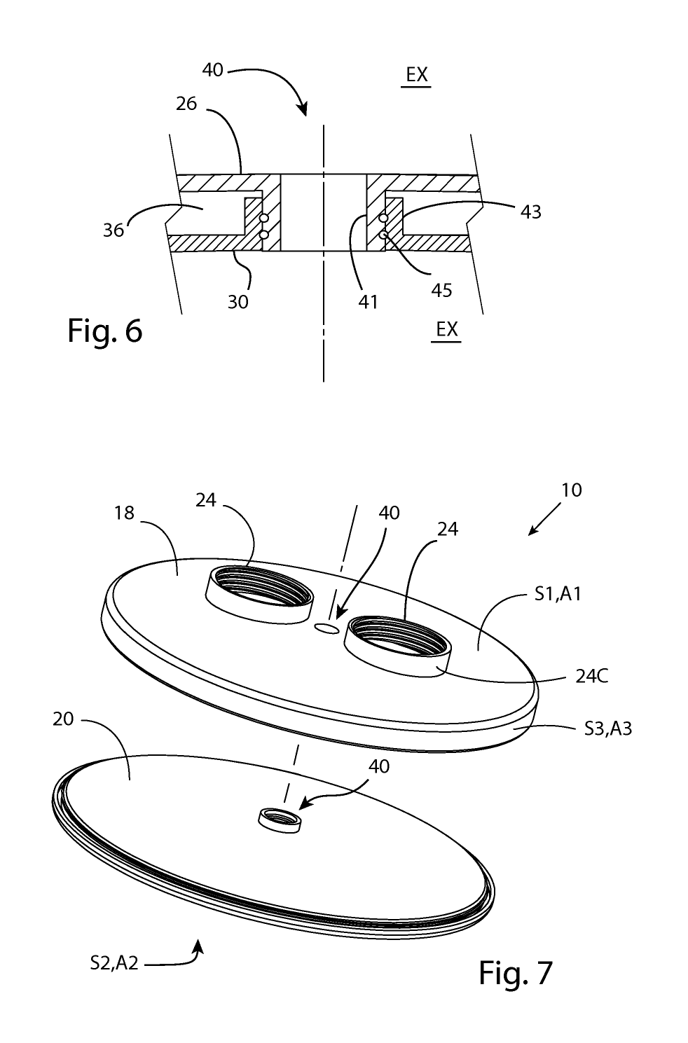

FIG. 6 shows details of an embodiment of the duct 40, which may include a first member 41 and a second member 43. For example, the first member 41 may be formed as a cylindrically shaped male hollow shaft, which may be integral with the first wall 26 and may project away therefrom toward the second wall 30, to be received in the second member 43. The second member 43 may be formed as a cylindrically shaped female hollow raised ridge that may be integral with the second wall 30 and may project away therefrom towards the first wall 26.

When the first and second shells, respectively 18 and 20 are coupled together to form the exemplary embodiment depicted in FIG. 5B, the first member 41 may be snuggly received within the second member 43 to protrude slightly away beyond the outer face of the second wall 30. One or more seals 45, for example two rubber rings or two O-rings (Trademark), as depicted in the partial cross-section shown in FIG. 6, may be disposed between the first and the second members, respectively 41 and 43, to hermetically seal the so formed hollow duct 40. Thereby, the hollow duct 40 provides a hermetically sealed passage for fluid communication from the exterior EX on the side of the first wall 26 to the exterior EX on the side of the second wall 30, through the interior volume 36. This means that the interior 36 of the container 10 remains hermetically sealed from the exterior EX even though being pierced throughout by the duct 40.

FIG. 7 depicts another exemplary embodiment of a container 10 where more than one opening 24 is entered therein. In an example shown in FIG. 7, two openings 24 are formed in the first shell 18, for coupling ancillary devices 16 thereto for example. However, more openings 24 may be provided in one of the first shell 18 and the second shell 20, or in both shells. Hence, the container 10 may have at least one through opening 24 formed through at least one of the two walls, respectively 26 and 30 for providing liquid communication between the interior volume 36 and the exterior EX of the container 10.

The exemplary embodiments of the container 10 described hereinabove have been shown in the accompanying figures as having two shells, respectively 18 and 20 that are separable to be opened, e.g. for ease of cleaning. If desired, the container 10 may be made as a unitary device, thus as a one-piece product. Such a single-piece-part made container 10, which cannot be opened for cleaning may furthermore be practical as a single-use disposable item made out of one or of more of rigid, semi-rigid, flexible and/or pliable material(s). The container 10 may be implemented out of materials approved for use with biological food, or with feeding devices, and may be produced by industrial equipment and processes well known to those skilled in the art.

The container 10 may be used in various ways, namely with breast milk, or with liquid for short, for collecting, cooling, storing, heating, and for transferring liquid. For the collection of breast milk, the cap C may be removed from the opening 24, which may then be coupled to a milk pump 16P that will be operated to fill the container 10. For storage, the container 10 may be disengaged from the milk pump 16P, and a cap C may be used to seal the container 10 before being stowed in a cooling apparatus such as a refrigerator or a freezer. For heating, the container 10 may be retrieved out of storage, the cap C may be removed therefrom, and an ancillary device 16, such as an open nursing bottle 16B may then be coupled to the open opening 24. In turn, heating may proceed by immersion into a hot fluid 14, while the container 10 may be manually held by say the nursing bottle 16B serving as a handle 16H. Alternatively, an adapter 38 may serve as a handle 16H.

When the container 10 is coupled to a nursing bottle 16B and is retrieved out of immersion from a heating liquid 14, transfer of the consumable feeding liquid FL into a nursing bottle 16B is simple: this may be achieved by simply overturning the container 10, for the latter to become disposed higher up and above the baby bottle 16B. Gravitation will cause the feeding liquid FL to flow into the baby bottle 16B. Once the feeding liquid FL is contained in the baby bottle 16B, the container 10 may be disconnected from the nursing bottle and a nursing teat BT may be coupled to the baby bottle 16B to feed the baby.

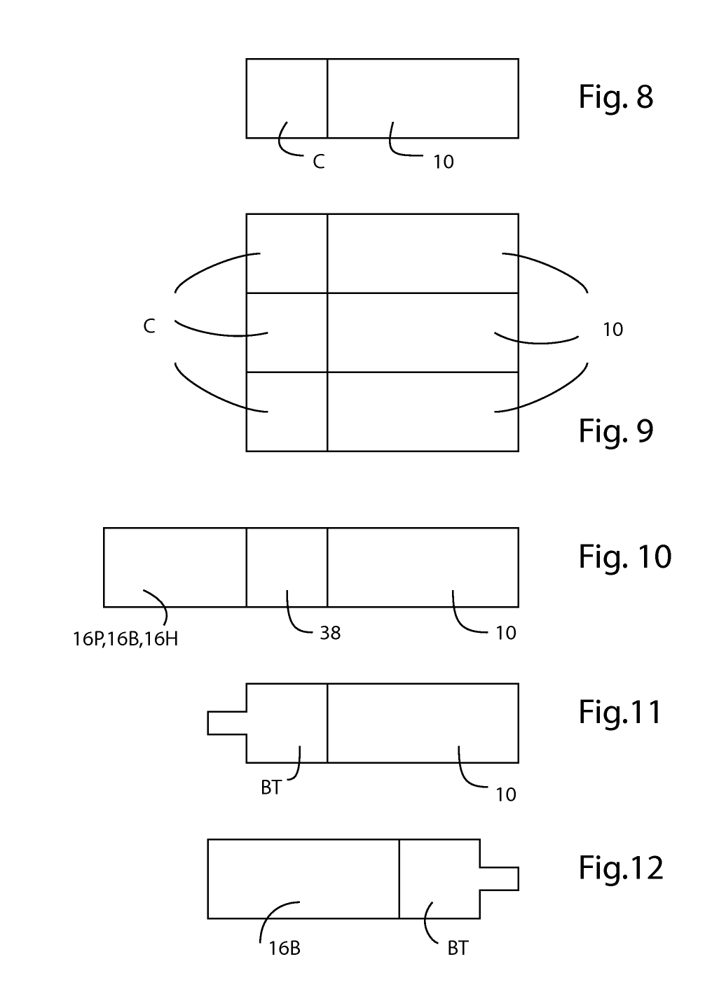

As described hereinabove, the container 10 may be coupled to a plurality of devices in various configurations which are schematically depicted in FIGS. 8 to 12. Such plurality of devices include adapters 38, breast milk pumps 16P, nursing bottles 16B, caps C, dedicated handles 16H, and feeding bottle teats BT. Coupling to devices may be achieved by use of one or more adapters 38 made of rigid or semi-rigid material. Although shown as a straight tube in FIG. 4A, one open end of an adapter 38 may be larger than the other open end. Furthermore, the adapter 38 may have male or female screwthreads on one or on both openings. Alternatively, the adapter 38 may be coupled to the plurality of devices in snap fit instead of by screwthreads. Moreover, the adapter 38 may be curved or configured according to desire, or even made to be bendable in situ.

FIG. 8 shows the container 10 as a unit hermetically closed by a cap C in, for example, a storing configuration. FIG. 9 depicts an exemplary stack of containers 10 with, for example, three containers 10 that are disposed in stacking on top of each other, thus one on top of the other. In FIG. 10, the cap C has been removed from the container 10 which is shown coupled to a breast milk pump 16P via an adapter 38, for the extraction of breast milk that is pumped into the container 10. The coupling of one or more adapters 38 between the breast milk pump 16P and the container 10 is an option which may be used if needed. Once filled with feeding liquid FL, the container 10 may be uncoupled from the breast milk pump 16P and from the adapters 38 if present. Next, the container 10 may be hermetically sealed with the cap C for storage, in refrigeration for example, in a configuration shown in FIG. 8. Optionally, for baby feeding purposes, a feeding bottle teat BT may be releasably but hermetically coupled directly to the container 10 or via an adapter 38, which is not shown in FIG. 11. Alternatively, the container 10 holding feeding liquid FL may be coupled to a baby bottle 16B, with or without use of an adapter 38. To fill the nursing bottle 16B with the feeding liquid FL held in the container 10 by use of gravity, the container 10 is simply disposed higher up above the nursing bottle 16B. A feeding bottle teat BT may be coupled to the feeding bottle 16B for feeding an infant, as seen in FIG. 12.

Alternatively, the breast milk pump 16P may be coupled directly to a nursing bottle 16B, or via an adaptor 38 as shown in FIG. 10, for the extraction of breast milk that is pumped into the nursing bottle 16B. The coupling of one or more adapters 38 between the breast milk pump 16P and the nursing bottle 16B is an option which may be used if needed. At the end of breast milk extraction, the nursing bottle 16B is uncoupled from the breast milk pump 16P. Once the amount of breast milk contained in the nursing bottle 16B is assessed, a container of appropriate volume capacity may be selected with the intention to completely fill, or almost fill the container 10. The less volume of air remaining trapped in the container 10, thus the more feeding liquid FL contained therein in contact with the surfaces S, the better the heat transfer process.

FIG. 10 shows a coupling configuration of the container 10 which is appropriate for treating the feeding liquid FL after retrieval thereof out of refrigeration for example. An empty nursing bottle 16B or a dedicated handle 16H may be releasably but hermetically coupled via an optional adaptor 38 to a container 10 and be held manually for immersing the container in fluid 14 having a thermal capacity. Evidently, an adaptor 38 may be coupled to the container 10 for the same purpose. Once the feeding liquid FL has reached the desired temperature, the adaptor 38, or the dedicated handle 16H may be removed and replaced by an empty nursing bottle 16B which may be filled by help of gravity. Thereafter, a feeding bottle teat BT may be coupled to the feeding bottle 16B for feeding an infant, in the configuration seen in FIG. 12.

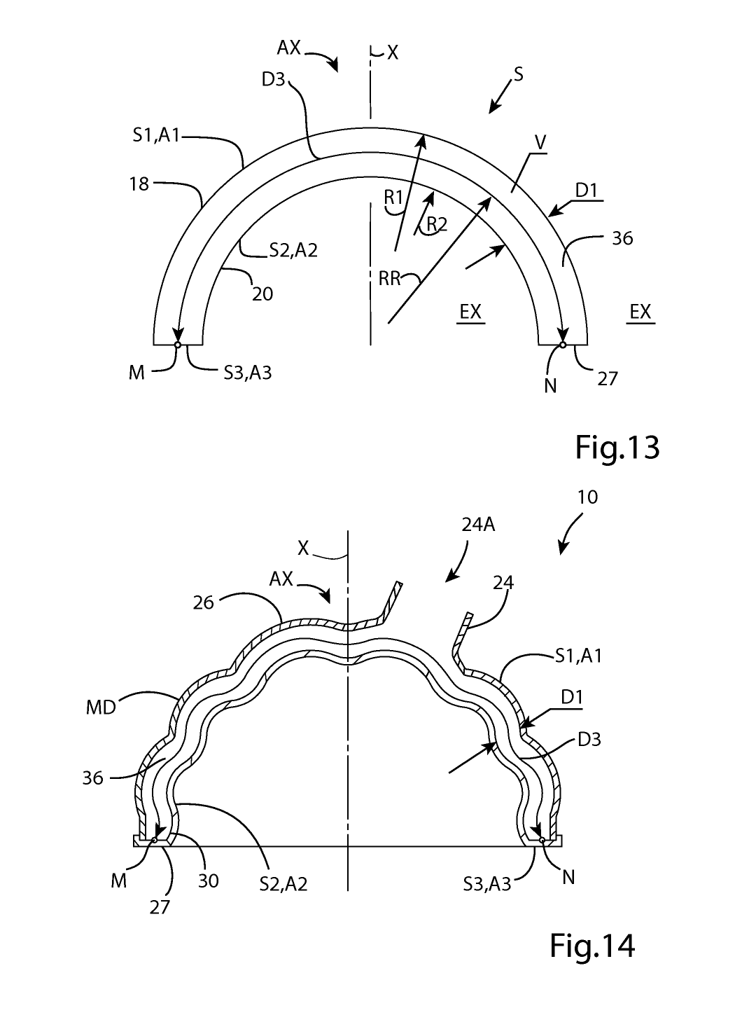

FIG. 13 schematically illustrates the geometry of the interior volume 36 as a cross-section cut axially through a curved container 10, which is shown as a dome-shaped container 10. The exemplary embodiment of the container 10 is depicted as a hemispherical dome for the sake of ease of description and of drawing but may be selected in the form of various symmetric or asymmetric three dimensional planar or curved body shapes if desired. Features such as, amongst others, at least one through opening 24, a hollow duct 40, assembly details and other qualities of the container 10 are not shown in FIG. 13 for the sake of clarity.

In FIG. 13, the surfaces S1, S2, and S3 of the container 10 form the interior volume 36. S1 represents the interior surface of the first shell 18, S2 the interior surface of the second shell 20 and S3 the closed periphery 27 extending between the first and the second shells, respectively 18 and 20. Since the first and the second shells 18 and 20 are thin, say about one millimeter thick, the areas A of the surfaces S in the interior volume 36 and on the exterior EX of the container 10 may be considered as being the same. For example, the surfaces S1, S2, and S3 may be accepted as having the same areas, respectively A1, A2, and A3, on both the exterior EX of the container 10 and in the interior volume 36 thereof. One may accept that S is the sum of the surfaces S1+S2+S3, and that the areas A of the surfaces S is the sum of the respective areas A1+A2+A3, either in the interior volume 36 or on the exterior EX of the container 10.

The surfaces S1 and S2 may run substantially parallel to each other and are separated apart by a shortest distance between each other which is substantially a uniform first distance length dimension D1. When starting to fill the interior volume 36 of FIG. 13 for example, the feeding liquid FL will be distributed to form a layer of substantially uniform thickness D1. The word ‘substantially’ is used to denote that even though the first distance length dimension D1 is uniform in the interior volume 36, there may be an exception. At the aperture 24A of the through opening 24, which is opened in the surface S1, thus in the first wall 26, there is but one wall left opposite the aperture 24A, namely the second wall 30. Therefore, rigorously speaking, if the interior volume 36 is filled up to the apex AX and the through opening 24 is disposed at the apex AX, the thickness of the layer of feeding liquid FL may be slightly different at the through opening 24. Furthermore, at the aperture 24A of the through opening 24 it is not possible to measure a distance between two walls since only the second wall 30 exists. The word ‘substantially’ used in association with the first distance length dimension D1 thus denotes a minute local singular discrepancy occurring at the through opening 24. Such a discrepancy may be disregarded, but for the sake of exactitude, is denoted by the word ‘substantially’.

With the interior volume 36, the first distance length dimension D1, or dimension D1, is much smaller relative to a curved third distance length dimension D3, or dimension D3. The third distance dimension D3 may cross the axis X of the container 10, and may have at least one radius of curvature RR. The at least one radius of curvature RR may be infinite for a planar container 10. The curved third distance dimension D3 may extend substantially in the middle of, thus amidst the first distance D1, and between two opposite portions of the closed periphery 27 of the embodiment of the curved container 10 shown in FIG. 13. The first distance D1 may thus extend between two radially opposite portions for the hemispherical dome. Hence, the third distance D3 may pass from a first end point M disposed on the closed periphery 27, then for example through the apex AX, and finally reach a second end point N on the same periphery 27 but diametrically opposed to the first end point M. The third distance D3 may be accepted as being the longest distance passing amidst the first distance D1 and between two end points, respectively M and N that are disposed on the periphery 27. In FIG. 13, the radius of curvature RR of the curved third distance dimension D3 is smaller than the first radius of curvature R1 of the first surface S1 but larger than the second radius of curvature R2 of the second surface S2.

The container 10 may be selected to have a desired shape, planar as a cylinder or curved like a bell, or have a cross-section in the shape of the inverted letter U. Other potential body shapes for the container 10 may be regular or not, symmetric or asymmetric, or in the form of a cone frustum or a pyramid frustum. However, the first straight dimension distance D1 separating between parallel surfaces S1 and S2 to form a substantially uniform layer of feeding liquid FL is a feature common to the various potential body shape selected for the container 10.

The third distance length dimension D3 of the container 10 may be a line segment, straight or not, which terminates at two distinct end points, shown for example as first and second points, respectively M and N in FIG. 13. This means that for a hemisphere for example, the curved third distance length dimension D3 may have at least one radius of curvature RR, or practically no radius of curvature RR, as with a container 10 shaped a flat cylinder, where the radius of curvature RR is infinite. Hence, with the container 10, the third distance length dimension D3 may become a straight line, thus become the second length dimension D2 for a planar or slightly curved container 10, as shown in FIG. 3. One may thus say that the third distance D3, for a curved container 10, is a second distance D2 that is curved. Furthermore, the third distance length dimension D3 may include a combination of line segments, straight and curved, as may be the case for a cross-section through the apex of a cone frustum-shaped container 10. For example, a third distance length dimension D3 having a plurality of curved line segments is shown in FIG. 14. Hence, the third distance length D3 may have one or more radii of curvature R, either concentric or not, as shown respectively, in FIGS. 13 and 14. It is noted that the third distance length D3 may have at least one straight line segment, as shown for example in FIG. 3.

In FIG. 14, the third distance length dimension D3 passing amidst the first distance length dimension D1 in the interior volume 36 conforms to the wavy shape caused of the matching surface deformations MD. Here too, the third dimension D3 starts at a first endpoint M, crosses the apex AX of the container 10 and terminates at the second endpoint N. The singular local instance of discrepancy occurring at the through opening 24 and described hereinabove with respect of the first length dimension D1 is valid and applicable to the third dimension D3. With respect to the hollow duct 40 and for the sake of exactitude, it may be accepted that the third dimension D3 circumvents the hollow duct 40 instead of crossing therethrough even in the absence of the first and the second walls, respectively 26 and 30.

To ensure a superior and rapid heat exchange process between a fluid 14 having a thermal capacity that is disposed on the exterior EX of the container 10, and with the feeding liquid FL held in the interior volume 36 in a layer shallow of thickness D1, the ratio between the third distance D3 and the first distance D1 has to be large. For example, the ratio of the third distance D3 to the first distance D1 may be selected as at least ten, or at least twenty, or even in excess thereof. In other words, the denomination of the areas A of the total surfaces S of the container 10 may be numerically larger by order(s) of magnitude than the first distance D1, such as for example by at least two, three, or four orders of magnitude. This means that the interior volume 36 has surfaces S with areas A having a denomination that is numerically larger by at least two, three, or four orders of magnitude than the denomination of the first distance length D1. It may also be said that the interior volume 36 has a volume capacity V having a denomination that is numerically larger by at least two, three, or four orders of magnitude than the denomination of the first distance length D1.

For example, with a first distance D1 of 0.8 centimeters and an area A of say about 300 square centimeters, the denomination 300 of the areas A of the total surfaces S of the container 10 is numerically larger by at least three orders of magnitude than the first distance D1.

In use, care may preferably be taken to select an appropriate container 10 that has an interior volume 36 with a volume capacity V that may be completely or almost completely filled with the selected quantity of feeding liquid FL. The aim is to provide good direct contact between the feeding liquid FL and as much as possible of the surfaces S, and to prevent air, or bubbles of air to remain in the container 10 to ensure enhanced heat exchange properties. Therefore, containers 10 of various capacities may be supplied, for example with volume capacities V ranging from less than 100 cubic centimeters to more than 400 cubic centimeters. Such containers 10 may have a volume capacity V with a denomination that is numerically larger by at least two, three or four orders of magnitude than the denomination of the first distance D1.

To augment the total areas A of the surfaces S of the container 10, thus to further enhance the heat transfer process, the first and the second walls, respectively 26 and 30 may have mutually matching surface deformations MD, shown in the schematic cross-section of FIG. 14. Such mutually matching surface deformations MD may include radial convolutions extending radially away from the axis X towards the closed periphery 27, or as convolutions concentric with the axis X or with the closed periphery 27, or as a combination of various types of convolutions, or as dimples like those of golf balls, or as protrusions-and-recessions capable of augmenting the total areas A by 50%, or by a factor of two, or even more than that. The first and the second shells, respectively 26 and 30, may be indexed to allow assembly such that the mutual surface deformations MD match mutually, as shown in FIG. 14 for example. In other words, the first wall 26 and the second wall 30 of the container 10 may have matching surface deformations MD such as radial convolutions, axial convolutions, dimples, and protrusions-and-recessions, either alone or taken in combination.

In general, treatment of the feeding liquid FL may include pumping, storage, heat exchange, transfer of liquid, and agitation, which may accelerate and enhance heat transfer between the feeding liquid FL and a fluid 14 having a thermal capacity. This may be achieved by agitation of the container 10 when immersed into and thus in contact with a fluid 14 having a thermal capacity for exchanging heat therewith, which medium 14 is disposed on the exterior EX of the container 10. For this purpose, a nursing bottle 16B, or an adaptor 38, or a dedicated handle 16H that may be held manually, may be coupled to the container 10 via at least one through opening 24 which is also adapted for coupling with a cap C, a breast milk pump 16P and a feeding bottle teat BT.

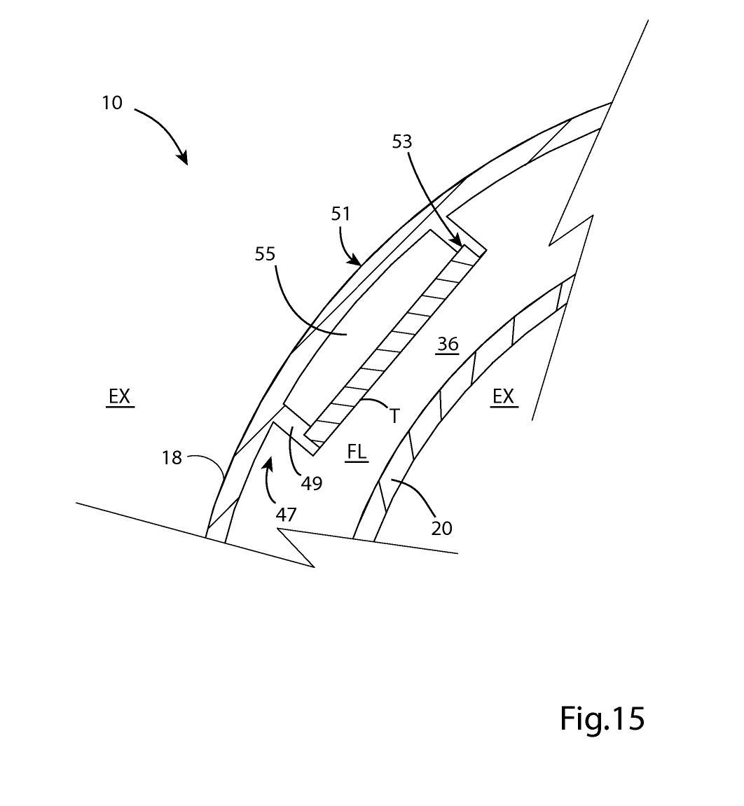

FIG. 15 refers to another exemplary embodiment of the container 10 and illustrates a partial cross-section of a portion of the first shell 18. A temperature deriving device T may be added to the first shell 18 for displaying a temperature level of the feeding liquid FL contained in the interior volume 36 for the purpose of providing a feedback to a user, which is not shown. FIG. 15 depicts a shallow receptacle 47 having protruding walls 49 that protrude out of a window portion 51 of the first shell 18 and into the interior volume 36. The protruding walls 49 may have shoulders 53 for supporting the temperature deriving device T which may close the receptacle 47. The temperature deriving device T, or thermometer T, may be supported on a closure plate that may be glued or soldered by ultrasound for example, onto the shoulders 53, to hermetically seal close the receptacle 47. However, an insulating layer 55, say of air, may remain disposed between the window portion 51 of the shell 18 and the thermometer T to insulate the thermometer T from the exterior EX for the purpose of displaying temperature level readings derived from the feeding liquid FL rather than from the exterior EX. Evidently, the window portion 51 of the shell 18 should be transparent to permit reading of the display of the thermometer T. This means that the window portion 51 of the first shell 18 may be configured as a transparent window 51 that is embedded in the first shell 18 or that a portion of or the or the entire shell 18 may be transparent or at least translucent. If desired, the temperature deriving device T may be coupled to the second shell 20.

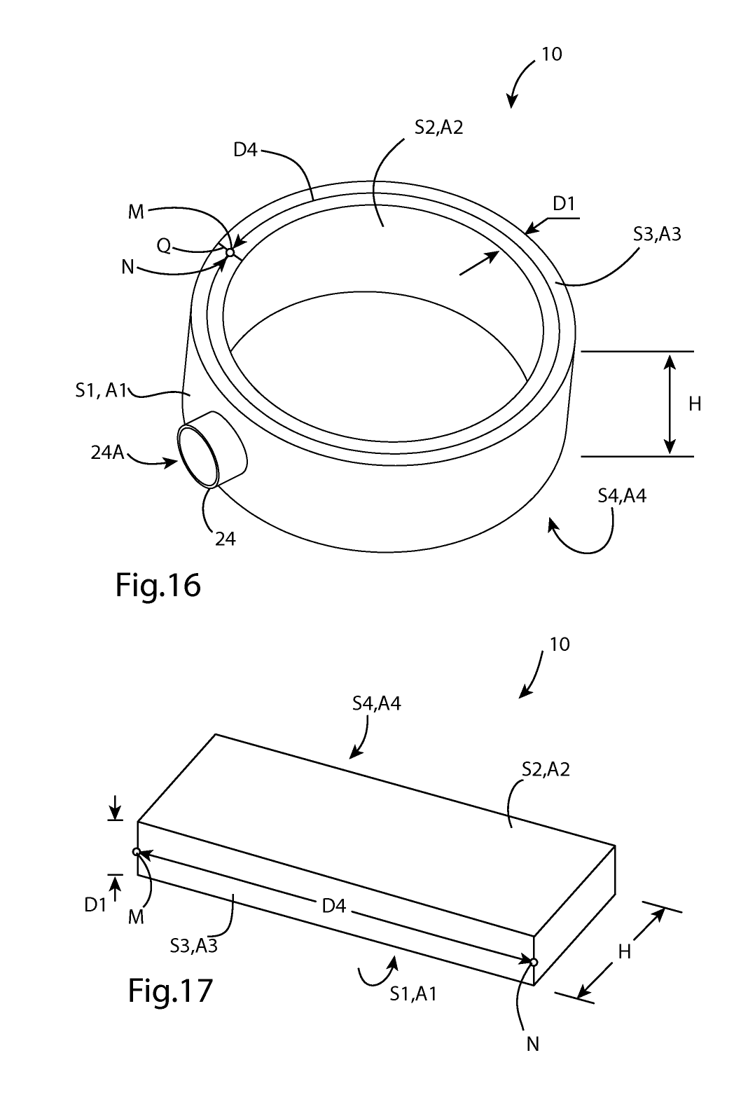

FIG. 16 illustrates still another exemplary embodiment of the container 10 configured as a sleeve 57 and having a first distance dimension D1, a fourth distance length dimension D4, and a height H. The total surfaces S are the sum of the first, second, third and fourth surfaces, respectively S1, S2, S3, and S4. The first distance dimension D1 is the thickness of the wall of the sleeve 57 and the fourth distance dimension D4 is the length of the circumference of a cylinder passing amidst the first and the second surface, respectively S1 and S2, indicated in FIG. 16 as the distance extending from the first end point M to the second end point N. The sleeve 57 may be unfolded by taking a cut starting on the line Q and extending along the height H of the sleeve 57. When the sleeve 57 is unfolded as shown in FIG. 17, which is not to scale, the second surface S2 may be disposed flat above the first surface S1 which is placed parallel thereto but at a first distance D1 therefrom. The through opening 24 of the container 10 is not seen in FIG. 17. Hence, the sleeve 57 is a container 10 having a first distance length dimension D1, where the curved fourth distance length dimension D4, extending from the first end point M to the second end point N, is equivalent to the second straight distance length dimension D2 shown in FIG. 3.

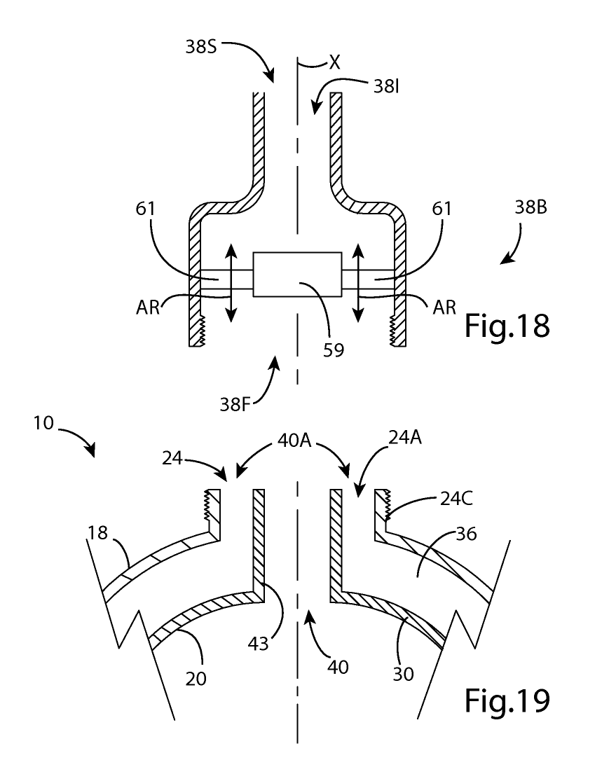

With the sleeve 57, the end points M and N coincide as and at one same point which is disposed on the line Q in FIG. 16. One may thus say that the fourth distance length dimension D4 may be unfolded from the form of a closed loop into a third distance length dimension D3 or into a second distance length dimension. At least one through opening 24 of the sleeve-shaped container 10 shown in FIG. 16 may be disposed on the first, second, third or fourth surface, respectively S1, S2, S3, and S4. An adapter 38 may be coupled to a through opening 24. However, if the first distance D1 is smaller than a regular through opening 24, an adapter 38B shown in FIG. 18 may have one smaller opening 38S and one larger opening 38F that may be fit for coupling to a regular through opening 24. The smaller opening 38S may be coupled to a small through opening that may be disposed on one of the surfaces S3 or S4.

FIG. 19 illustrates a detail of yet another exemplary embodiment of the container 10 having a hollow duct 40 aligned with the axis X and concentric with a through opening 24. In contrast with the configuration of the hollow duct 40 shown in FIG. 6, the second member 43 protrudes out of the second wall 30, or second shell 20, but the first member 41 is superfluous. The second member 43 may end flush with the aperture 24A of the through opening 24, but has to be configured such that a cap C may hermetically seal close both the duct 40 and the annular passage 40A concentric with the duct 40, which now forms the at least one through opening 24 for bidirectional flow therethrough of feeding liquid.

For bidirectional liquid communication between say a baby bottle 16B and a container 10 having a hollow duct 40 disposed in concentricity with a through opening 24, an adaptor 38 having a plug 59 configure to seal close the hollow duct 40 may be necessary. FIG. 18 shows a modified adaptor 38B similar to the adaptor 38 shown in FIG. 4A but having a plug 59 which is supported by two wings 61. The plug 59 may be supported by one or more wings 61 appropriately disposed in the interior duct 38I of the adaptor 38B to allow free bidirectional passage of liquid, as shown by the double headed arrows marked AR. The adaptor 38B may have end apertures 38F and 38S of different size.

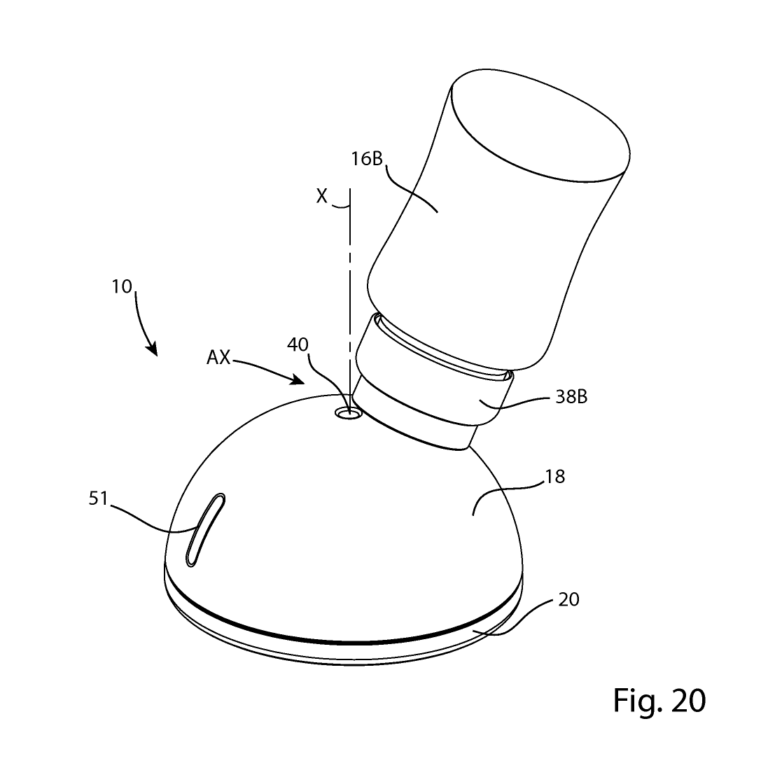

FIG. 20 illustrates a container 10 to which a feeding bottle 16B is coupled via a modified adapter 38B. The container 10 is configured as a spherical cap or as a hemisphere. A hollow duct 40 is disposed axially at the apex AX of the container 10 but the feeding bottle 16B is coupled off the axis X. Since the through opening 24 may be oriented in a selected desired orientation, the same is true for the feeding bottle 16B. A window portion 51 wherethrough a thermometer T may be seen is disposed on the first shell 18.

There has thus been described a container 10 having a curvature, and a method for treating a biologically compatible feeding liquid FL which is held in the hermetically closeable curved container (10). The container 10 is configured to have a first wall 26, a second wall 30 and a closed periphery 27 for forming an interior volume 36 accommodated for holding the feeding liquid FL therein. The method further comprises the step of separating the first wall 26 and the second wall 30 by a substantially uniform parallel first distance length D1 whereby the feeding liquid FL is held in the container as a layer of uniform thickness. Moreover, there is defined a curved third distance length D3 which is longer by at least five times, or ten times, or twenty times, or even more, than the first distance D1. The length of the third distance D3 extends substantially amidst the first distance D1 and spans between two opposite end points M and N which are disposed on the closed periphery 27.

While the invention has been illustrated and described in detail in the drawings and foregoing description, such illustration and description are to be considered illustrative or exemplary and non-restrictive; the invention is thus not limited to the disclosed embodiments. Variations to the disclosed embodiments may be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be considered as limiting their scope.

Although the present embodiments have been described to a certain degree of particularity, it should be understood that various alterations and modifications could be made without departing from the scope of the invention as hereinafter claimed. For example, for ease of storage of the container 10, one may consider the addition of legs or fins, which are not shown in the Figs. Furthermore, the duct 40 may be used to stack containers 10 on a spike or on a rod.

### INDUSTRIAL APPLICABILITY

The container 10 described hereinabove is adequate for industrial applicability and may be made by producers and manufacturers.

### REFERENCE SIGNS LIST

A total area
A1 area of first surface
A2 area of second surface
A3 area of third surface
AR arrow
AX apex
BT feeding bottle teat or teat
C cap
C1 cap for through opening
C2 cap for adaptor
D1 first distance dimension
D2 second distance dimension
D3 third distance dimension
D4 fourth distance dimension
F front, forward direction
FL feeding liquid
H height
M first end point
MD mutually matching surface deformation
N second end point
Q line
R rear, rearward, rear direction
RR radius of curvature
R1 first radius of curvature
R2 second radius of curvature
S total surfaces
S1 first surface
S2 second surface
S3 third surface
T temperature deriving device or thermometer
V volume capacity
10 container
12 vessel
14 fluid with a thermal capacity
16 ancillary device
   16B nursing bottle
   16P breast milk pump
   16H handle
18 first shell
20 second shell
22 sealing element
24 through opening
24A aperture of through opening
MD matching surface deformations
24C collar
26 first wall
27 closed periphery
28 first peripheral envelope
29 peripheral extremity of 28
30 second wall
32 second peripheral envelope
33 peripheral extremity of 32
34 peripheral lip
36 interior volume
38 adapter
38B modified adaptor
38F first open end
38I interior duct
38S second open end
40 hollow duct
40A annular passage
41 first member
43 second member
45 seal
47 receptacle
49 protruding walls
51 window portion
53 shoulder in receptacle
55 insulating layer
57 sleeve
59 plug
61 wing

We claim:

1. A container for a consumable liquid, wherein the container has a first wall and a second wall separated apart by a closed periphery and is configured to form an interior volume which is separated apart from an exterior of the container and holds therein the consumable liquid,
wherein the container has at least one through opening formed through at least one of the first wall and the second wall to provide liquid communication between the interior volume and the exterior of the container, and
wherein the container includes a hollow duct configured to provide an hermetically sealed bidirectional fluid communication passage across the interior volume, from a side of the first wall on the exterior to the exterior of a side of the second wall.

2. The container of claim 1, wherein the at least one through opening is configured to couple with an ancillary device which is selected as at least one of a nursing bottle, a breast milk pump, an adapter, a dedicated handle, a cap, and a feeding teat.

3. The container of claim 1, wherein:
a shallow receptacle protrudes out of a transparent window portion of a first shell into the interior volume to support therein a temperature deriving device which closes the receptacle and is insulated from the exterior, and
wherein the temperature deriving device is configured to display a temperature level of the consumable liquid contained in the interior volume.

4. The container of claim 3, wherein:
the temperature deriving device is a thermometer, and
an insulating layer of air is disposed between the window portion and the thermometer.

5. The container of claim 1, wherein:
the at least one through opening is configured to be coupled to one of a cap or a feeding teat, and
the container coupled to the cap is configured for storage of a plurality thereof in a stack.

6. The container of claim 1, wherein the hollow duct is used to stack a plurality of containers on a spike or on a rod.

7. The container of claim 1, wherein the container is disposable and is configured as a single-piece-part made for single-use out of at least one of a rigid, a semi-rigid, a flexible, and a pliable material.

8. A container for a consumable liquid, wherein the container has a first wall and a second wall separated apart by a closed periphery and is configured to form an interior volume which is separated apart from an exterior of the container and holds therein the consumable liquid,
wherein the container has at least one through opening formed through at least one of the first wall and the second wall to provide liquid communication between the interior volume and the exterior of the container,
wherein a shallow receptacle protrudes out of a transparent window portion of the first wall into the interior volume to support therein a temperature deriving device which closes the receptacle and is insulated from the exterior, and
wherein the temperature deriving device is configured to display a temperature level of the consumable liquid contained in the interior volume.

9. The container of claim 8, wherein:
the temperature deriving device is a thermometer, and
an insulating layer of air is disposed between the window portion and the thermometer.

10. The container of claim 9, wherein the at least one through opening is configured to couple with an ancillary device which is selected as at least one of a nursing bottle, a breast milk pump, an adapter, a dedicated handle, a cap, and a feeding teat.

11. The container of claim 8, wherein:
the at least one through opening is configured to be coupled to one of a cap or a feeding teat, and
the container coupled to the cap is configured for storage of a plurality thereof in a stack.

12. The container of claim 8, wherein the hollow duct is used to stack a plurality of containers on a spike or on a rod.

13. The container of claim 8, wherein the container is disposable and is configured as a single-piece-part made for single-use out of at least one of a rigid, a semi-rigid, a flexible, and a pliable material.

14. A method for providing an hermetically closeable curved container for holding therein a biologically compatible feeding liquid, the container having a first wall, a second wall, and a closed periphery for forming an interior volume, the method comprising:
disposing at least one through opening in the container through at least one of the first wall and the second wall to provide liquid communication between the interior volume and an exterior of the container, and
providing a shallow receptacle protruding out of a transparent window portion of the first wall into the interior volume for supporting therein a temperature deriving device closing and insulating the receptacle from the exterior, and
implementing the temperature deriving device for displaying a temperature level of the consumable liquid contained in the interior volume.

15. The container of claim 14, wherein the temperature deriving device is a thermometer.

16. The container of claim 15, wherein an insulating layer of air is disposed between the window portion and the thermometer.

17. The container of claim 15, wherein the at least one through opening is configured to couple with an ancillary device which is selected as at least one of a nursing bottle, a breast milk pump, an adapter, a dedicated handle, a cap, and a feeding teat.

18. The container of claim 14, wherein the container is disposable and is configured as a single-piece-part made for single-use out of at least one of a rigid, a semi-rigid, a flexible, and a pliable material.

19. The container of claim 14, wherein the container includes a hollow duct configured to provide an hermetically sealed bidirectional fluid communication passage across the interior volume, from a side of the first wall on the exterior to the exterior of a side of the second wall.

20. The container of claim 14, wherein the at least one through opening is configured to couple with an ancillary device which is selected as at least one of a nursing bottle, a breast milk pump, an adapter, a dedicated handle, a cap, and a feeding teat.
